(19) United States
(12) Patent Application Publication
(10) Pub. No.: US 2011/0215563 A1
(43) Pub. Date: Sep. 8, 2011

(54) STRUCTURE COMPRISING A WATERMARK OR PSEUDO-WATERMARK, AND AN INTEGRATED MICROCIRCUIT DEVICE

(75) Inventors: Sandrine Rancien, La Murette (FR); Thibaut Le Loarer, Pommier de Beaurepaire (FR); Gaetan Le Gouic, Marseille (FR)

(73) Assignee: ARJOWIGGINS SECURITY INTEGRALE SOLUTIONS, Jouy sur Morin (FR)

(21) Appl. No.: 13/000,898

(22) PCT Filed: Jun. 22, 2009
(86) PCT No.: PCT/FR2009/051191

§ 371 Date: Apr. 28, 2011

(30) Foreign Application Priority Data
Jun. 24, 2008 (FR) 08 54200

(51) Int. Cl. B42D 15/00

(52) U.S. Cl. 283/113

(57) ABSTRACT

The invention provides a structure comprising:
a fiber layer;
a sub-structure including a translucent region;
a watermark or pseudo-watermark carried by the fiber layer and superposed at least in part with the translucent region of the sub-structure, such that, in the translucent region of the sub-structure, the watermark or pseudo-watermark is observable in light transmitted through the structure only from the face of the structure that is adjacent to the fiber layer; and
an integrated microcircuit device for communicating with or without contact.

The present invention relates to the field of security documents. It provides a structure, in particular a sheet, e.g. a security document including a watermark or pseudo-watermark and an integrated microcircuit device.

### BACKGROUND

In order to defend against counterfeiting or falsification of security documents such as: payment means, e.g. bank notes, checks; or such as official documents, e.g. passports, identity cards; or such as tickets for entry to cultural or sporting events; or transport tickets; it is possible to use various security means, such as for example watermarks that enable a document to be authenticated by observing it in transmitted light.

Watermarks provide protection against copying by optical means such as photocopying, photography, or digital scanning.

Watermarks may also be used for decorative and prestige purposes, in particular for writing/letter paper, e.g. for letterheads or art papers such as paper for water colors.

Watermarks are conventionally obtained during the wet stage of fabrication of a paper sheet by depositing the paper pulp on an embossed wire cloth of a vat former paper-making machine, the quantity of pulp deposited being thicker in the recesses and thinner on the projections compared with the remainder of the paper.

It is also possible to make watermarks by embossing a wet sheet using a watermarking roll (also known as a “dandy roll”) on a flat bed (fourdrinier) paper-making machine.

It is also known to make pseudo-watermarks on a sheet of paper. Pseudo-watermarks reproduce the appearance of a watermark by presenting differences of opaqueness. Such pseudo-watermarks may be obtained mechanically by applying pressure with or without heat and/or chemically by applying a composition, e.g. by locally increasing the transparency of the paper by using transparentizing substances. The density of the fiber material between the paler zones and the darker zones of a pseudo-watermark may be uniform, unlike a conventional watermark.

Furthermore, in order to increase the security level of security documents and make them more difficult to falsify, it is known to incorporate integrated microcircuit devices therein, in particular radio frequency identification (RFID) devices. Such devices, e.g. in the form of a chip associated with an antenna, serve to store and optionally to modify information specific to the bearer or to the article to which they relate, to the type of document issued, or to a history of events.

For example, RFID-containing identity cards made of plastics material are known that are made by assembling polymer layers together. Such cards include few or no authentication security elements, in particular for visual authentication, except sometimes surface embossing and holograms that are applied by transfer. As a result, it is relatively easy for a fraudulent person to reproduce the printing, the personalization, and the visual security features present on such cards, starting from a blank plastics material card.

Security cards are also known that include two polyethylene layers, each having a pseudo-watermark made by embossing indentations or projections, the two pseudo-watermarks combining when observed in transmitted light.

Applications WO 2005/062244 and WO 2004/008397 also describe security structures including electronic circuits and security elements, e.g. in the form of watermarks.

### SUMMARY

There exists a need to further reinforce the security of security documents.

In particular, there exists a need to provide novel security features against falsification and counterfeiting, which features should be easily observable while presenting a satisfactory level of security.

One of the objects of the present invention is thus to propose a security structure, in particular a security document, that includes an integrated microcircuit device and that presents a level of security and of resistance to falsification or to counterfeiting that is high.

Thus, in one of its aspects, the invention provides a structure, in particular a document, comprising:
a fiber layer;
a sub-structure including a translucent region;
a watermark or pseudo-watermark carried by the fiber layer and superposed at least in part with the translucent region of the sub-structure, such that, in the translucent region of the sub-structure, the watermark or pseudo-watermark is observable in light transmitted through the structure only from the face of the structure that is adjacent to the fiber layer; and
an integrated microcircuit device for communicating with or without contact.

The integrated microcircuit device may be carried by the sub-structure.

By means of the invention, it is possible to benefit from a security structure that includes an integrated microcircuit device, while also benefiting from the security associated with the presence of at least one watermark or pseudo-watermark.

### Watermark(s) or Pseudo-Watermark(s)

The structure may include a watermark carried by the fiber layer and overlying at least in part the translucent region of the sub-structure in such a manner that the watermark is observable in light transmitted through the structure in register with the translucent region only from the face of the structure that is adjacent to the fiber layer, i.e. the face of the structure remote from its face in contact with the sub-structure.

In a variant, the structure may include a pseudo-watermark carried by the fiber layer and overlying at least in part the translucent region of the sub-structure in such a manner that the pseudo-watermark is observable in light transmitted through the structure in register with the translucent region only from the face of the structure that is adjacent to the fiber layer, i.e. the face of the structure remote from its face in contact with the sub-structure.

The structure may include two fiber layers, the sub-structure being situated between the fiber layers. Under such circumstances, each of the fiber layers may include a watermark or pseudo-watermark that can be observed in light transmitted through the structure and in register with the translucent region of the sub-structure only from the face of the structure that is adjacent to the fiber layer carrying it. In this way, watermarks or pseudo-watermarks are observed in distinct manner from respective different faces of the structure.

In an embodiment of the invention, the structure presents a recto face and a verso face, comprising a first fiber layer carrying at least a first watermark or pseudo-watermark and a second fiber layer carrying at least a second watermark or pseudo-watermark, at least part of the first watermark or pseudo-watermark being observable in transmitted light only from the recto face of the structure and at least part of the second watermark or pseudo-watermark being observable in transmitted light only from the verso face of the structure. Furthermore, the watermarks or pseudo-watermarks are preferably juxtaposed at least in part in the translucent region of the sub-structure. These watermarks or pseudo-watermarks therefore are not observable simultaneously in transmitted light from one side or the other side of the structure in register with the translucent region of the sub-structure. The translucent region of the sub-structure may thus serve to prevent the watermarks or pseudo-watermarks being combined with each other.

The term “watermark or pseudo-watermark” is used in the invention to designate a drawn image that appears in the thickness of the structure.

The watermark or pseudo-watermark may be made in various ways known to the person skilled in the art.

The watermark may be a design etched or pressed into a fiber layer during fabrication thereof. By way of example, such a watermark may be seen in transparency by creating regions of smaller or greater thickness in the pulp during fabrication of the fiber layer on a vat former paper-making machine by means of a projecting or recessed impression in the wire cloth of the vat former. As a result, differences of opaqueness are created and zones with a greater density of pulp appear darker than zones that are less dense which appear paler than the remainder of the sheet (known as the vellum portion) when the (dried) sheet is observed in transmitted light. Watermarks that present different gray levels depending on the height or depth of the embossing are said to be “multi-tone” watermarks.

The watermark may also come from zones where the fiber layer has been pressed against a flat bed (fourdrinier) paper-making machine by a dandy roll that includes an etching of the watermark in relief, thereby having the effect of pressing hard against certain zones of the fiber layer and of expelling the water contained in the fibers while the fiber layer is being formed in the wet portion of the machine.

The pseudo-watermark may also be produced in the finished fiber layer by mechanical and/or chemical means by applying certain compositions, the design always being visible in transparency.

By way of example, the pseudo-watermark may be made by depositing or printing a composition onto determined zones of the fiber layer so as to modify the transparency of the fiber layer, in particular so as to produce zones that are pale and zones that are dark, similar to those of a watermark, but without obtaining a result that is capable of producing shading presenting fineness and variation that are comparable to those of a conventional watermark.

By way of example, the finished fiber layer may be transparentized by subjecting determined zones to a generally fatty composition, for example, which composition transparentizes the fiber layer in permanent manner, e.g. a composition made up of oil and transparent mineral matter as described in U.S. Pat. No. 2,021,141, or for example a composition in the form of a wax combined with a solvent as described in U.S. Pat. No. 1,479,337.

It is also possible to transparentize the finished fiber layer by locally pressing wax thereto by hot-transfer, as described in U.S. Pat. No. 5,118,526.

It is also possible to use a fiber layer including a hot-melt material, e.g. polyethylene, as described in patent EP 0 203 499, in which the transparency of the layer is caused to vary under the local action of heat.

It is also possible to opacify the finished fiber layer, without making it completely opaque, by applying an opacifying agent to determined zones thereof, which agent increases the opaqueness of the fiber layer, e.g. as described in patent application FR 2 353 676.

By way of example, the opacifying agent may be an aqueous suspension of a pigment or of a filler or a solution of a chemical compound, a colored compound or a dye. During fabrication of the fiber layer, the agent may be applied on the fiber sheet before it is removed from the wire cloth so that the agent penetrates into the interstices of the sheet and modifies the opaqueness of the sheet for treatment in selected zones, once the sheet is dry. That fabrication technique suffers from the drawback of requiring special roller devices for applying the agent, and of preferably making use of a suction device to cause the agent to penetrate into the interstices of the sheet.

It is also possible to make a pseudo-watermark using the method described in the document by W. Walenski entitled “Watermarks and those that are not”, Druckspiegel 52, No. 3: pp. 66-68 (March 1997). That document describes a method of fabricating a pseudo-watermark on non-coated paper, comprising applying a marker piece under heat and pressure against a re-wetted sheet of paper, which marker piece represents the pattern of the pseudo-watermark.

International application WO 97/17493 also describes fabricating coated paper including pseudo-watermarks that result from varying the weight of the applied coating in determined zones, thereby giving rise to a variation in thickness and opaqueness in the zones where the weight of the coating is reduced or increased.

International application WO 1999/014433 also describes another method of fabricating a pseudo-watermark on coated paper, which method provides for making an image in the paper after the drying step that follows the last coating operation, by performing steps in which a re-wetting solution is applied to at least one face of the coated paper in one or more determined zones, and pressure and heat are applied in said zone(s) of the re-wetted coated paper so as to evaporate the solution and densify the coated paper in the zone(s) relative to the remainder of the paper.

Finally, the pseudo-watermark may be made mechanically by mechanically embossing marks in determined zones of the fiber layer as described in patent DE 3 718 452.

When each of the two fiber layers includes a watermark or pseudo-watermark, the two watermarks or pseudo-watermarks may be different. In particular the watermarks or pseudo-watermarks may be complementary. They may be complementary in their visual effect or relative to a concept or an image. For example, in a structure of the invention, it is possible to use a national emblem as a first watermark or pseudo-watermark on one side, and to use a text as a second watermark or pseudo-watermark on the other side. With a purchase requisition, it is possible to use respectively the logo of the issuing company and the value of the order.

In another embodiment, both watermarks or pseudo-watermarks are identical and placed symmetrically. For authentication purposes, it may then be advantageous to verify this identity between the watermarks or pseudo-watermarks on both faces of the structure (e.g. a person always looking in the same direction).

In yet another embodiment, both watermarks or pseudo-watermarks face each other, at least in part.

### Integrated Microcircuit Device

The integrated microcircuit device may be adapted to contactless communication technology, e.g. that described in the ISO 14433 standard.

In a variant, the integrated microcircuit device may be adapted to the technology of communication via contacts, e.g. that described in the ISO 7816 standard.

The structure may include an integrated microcircuit device for communication via contacts and an integrated microcircuit device for communication without contacts, or an integrated microcircuit device making it possible both to read with contacts and to read without contacts. The integrated microcircuit device of the invention may in particular include two electronic modules, one for the technology using contacts and the other for contactless technology, e.g. for a hybrid smart card or for a contact/contactless double-sided electronic module for a dual smart card.

The integrated microcircuit device may be capable of communicating with an external reader. The term “external reader” is used to designate any device capable: of communication with the integrated microcircuit device; of activating it; of authenticating it; of reading data contained therein; of receiving said data, and where appropriate of modifying said data, or of deleting it in full or in part. The external reader may operate remotely or it may require contact.

The integrated microcircuit device may result from associating a chip with at least one antenna for a contactless system.

By way of example, the chip comprises a semiconductor base, generally a chip of doped silicon, sometimes made of a semiconductive polymer, and also generally including a memory, or even one or more microprocessors, suitable for processing data. In order to operate, it may receive energy from a battery, or it may be powered by an electrical power supply delivered via the contact and/or without making contact, i.e. remotely via a communications interface and the antenna. By way of example, the chip may be connected to the antenna for being supplied with contactless power of the inductive or capacitive type. Chips with on-board antennas are referred to as “transponders” and they generally use radiofrequency waves.

When the integrated microcircuit device is “active”, the chip may include a battery or a “microbattery”, integrated in its microcircuit, or it may be connected to a microbattery integrated in the structure. The term “battery” should be understood as designating a source of energy of electrochemical origin, which source may optionally be rechargeable.

The chip may also be powered by a photovoltaic system.

The antenna of the contactless integrated microcircuit device may be of the wired, printed, in particular silkscreen-printed, etched, adhesively-bonded, transferred, chemically deposited, or electroplated type, or indeed it may be carried by the integrated microcircuit device.

The antenna of the contactless integrated microcircuit device may be carried by a fiber layer, by the sub-structure, or by an adhesive layer, in particular an adhesive layer used for assembling one or more fiber layers and/or the sub-structure together.

The antenna may be situated on one of the faces of the sub-structure or it may be totally incorporated therein. The antenna may be made on the sub-structure before it is assembled with the fiber layer.

The antenna may be situated between the fiber layer and the sub-structure. In particular, the antenna may be carried by a face of a fiber layer that is in contact with the sub-structure. The antenna may be made on the fiber layer before it is assembled with the sub-structure.

The integrated microcircuit device may be situated on one of the faces of the sub-structure.

The integrated microcircuit device may be incorporated at least in part in a fiber layer.

In a variant, the integrated microcircuit device may be incorporated totally in the sub-structure.

The integrated microcircuit device may be visible at least in part in one of the faces of the structure, in particular when it is a device with contacts.

The integrated microcircuit device may be housed, at least in part, in the sub-structure, i.e. all or part of the thickness of the integrated microcircuit device is compensated by the sub-structure. By way of example, this makes it possible to protect the integrated microcircuit device, which is generally a fragile part, while also making access thereto by potential fraudulent people particularly difficult. The thickness of the integrated microcircuit device may also be compensated at least in part by an adhesive layer of the sub-structure, serving to assemble it with one or more fiber layers. The thickness of the sub-structure may exceed that of the integrated microcircuit device.

In an embodiment, the integrated microcircuit device is flush with at least one face of the sub-structure. The integrated microcircuit device may be flush with both faces of the sub-structure.

The integrated microcircuit device may be associated with, e.g. connected to, one or more of the electronic devices selected from the following list:
a light-emitting system, in particular a light-emitting diode (LED) or an organic LED (OLED);
a display device, e.g. a screen;
a sensor;
a coupling antenna; and
a switch.

The integrated microcircuit device may also include one or more of the above-mentioned electronic devices. In a variant, the electronic devices may be independent of the integrated microcircuit device, preferably being connected to the integrated microcircuit device via a wired, optical, or radio connection, e.g. by inductive coupling.

The electronic device(s) may be electrically powered by a battery present on the integrated microcircuit device, in particular by an on-chip microbattery.

The electronic device(s) may also be powered by an external battery that is not present on the integrated microcircuit device, e.g. a battery made up of flexible thin layers that are distinct from the chip or by a photovoltaic cell, e.g. a cell that is printed, at least in part.

The electronic device(s) may also be powered by capacitive or inductive coupling, e.g. during communication between the integrated microcircuit device and an external reader.

The electronic device(s), and optionally the associated power supply device(s), e.g. one or more batteries, may be housed in the thickness of one of the layers of the structure, or in a variant it may be printed on one of the layers of the structure.

In an embodiment, the electronic device(s) is/are added to the structure as additional security means optionally capable of interacting with the outside. For example, the electronic device may be a switch that actuates a light-emitting device.

The electronic device(s) may correspond to a detector. The detector may be configured to detect a change in at least one physicochemical magnitude. Detection may be performed outside the read field of an external reader capable of obtaining at least some information relating to said change from the integrated microcircuit device, and the integrated microcircuit device may be configured to inform the external reader during communication therewith of an attempt at violating the physical integrity of the structure as a result of detecting a corresponding change in said at least one physicochemical magnitude.

The integrated microcircuit device is advantageously suitable for storing the change(s) in memory.

The term “physicochemical magnitude” is used to designate a characteristic property or parameter intrinsic to the structure or to an element present in or on the structure, with the value of said property or said parameter being modified during a physical violation or intrusion of the structure.

In another embodiment of the invention, the electronic device(s) is/are incorporated in the structure in order to add a special function, e.g. associated with the integrated microcircuit device or with another electronic device. For example, the electronic device may be a photovoltaic cell that recharges a battery used by a sensor.

### Security Elements

The structure, in particular the sub-structure and/or the fiber layer(s) of the structure may include one or more security elements.

Amongst security elements, some are detectable by the naked eye, in daylight or in artificial light, without using any particular appliance. By way of example, these security elements comprise colored fibers or flakes, or threads that are printed or metal-plated in full or in part. These security elements are said to be of the “first” level.

Other types of security element are detectable solely with the help of a relatively simple appliance, such as a lamp emitting in the ultraviolet or the infrared. Such security elements comprise for example fibers, flakes, strips, threads, or particles. These security elements may optionally be visible to the naked eye, e.g. emitting light when illuminated by a Wood's lamp that emits at a wavelength of 365 nanometers (nm). These security elements are said to be the “second” level.

Still other types of security element require a more sophisticated detector appliance in order to be detected. By way of example, such security elements are capable of generating a specific signal on being subjected, to one or more external excitation sources, possibly simultaneously. Automatic signal detection enables the document to be authenticated, where appropriate. These security elements include, for example: tracers in the form of an active material, particles, or fibers, capable of generating a specific signal when the tracers are subjected to optoelectronic, electrical, magnetic, or electromagnetic excitation. These security elements are said to be of the “third” level.

The security elements present within the sub-structure and/or the fiber layer(s) may present security characteristics of the first, second, or third levels.

The structure, in particular the sub-structure, may in particular include the following as security elements, among others:
light-emitting pigments and/or dyes and/or interference pigments and/or liquid crystal pigments, in particular in printed form or mixed with at least one polymer of at least one layer of the sub-structure;
photochromic or thermochromic pigments and/or dyes, in particular in printed form or mixed with at least one polymer of at least one layer of the sub-structure;
an ultraviolet (UV) absorber, in particular in coated form or mixed with at least one polymer of the sub-structure;
a specific light-collecting material, e.g. of the “waveguide” type, e.g. a light-emitting light-collecting material such as polymer films based on polycarbonate and sold by the supplier Bayer under the name Lisa®;
an interference multilayer film;
a structure presenting variable optical effects based on interference pigments, or on liquid crystals;
a birefringent or polarizing layer;
a diffraction structure;
an embossed image;
means that produce a “moiré effect”, such an effect possibly causing a pattern to appear that is produced by causing two security elements of the sub-structure to overlie each other, e.g. putting lines of two security elements together;
a partially-reflective refractive element;
a transparent lenticular grid;
a lens, e.g. a magnifying glass; and
a colored filter.

The structure, in particular the sub-structure and/or the fiber layer(s) may also include as security elements, among others:
a security thread, e.g. incorporated in the body of one of the fiber layers or in a window, optionally including a positive or negative printed impression, fluorescence, or a metallic, goniochromatic, or holographic effect, with or without one or more demetallized portions;
a metallized, goniochromatic, or holographic foil;
a layer having a variable optical effect based on interference pigments or on liquid crystals;
a flat security element of relatively small format such as a flake that is visible or invisible, and in particular that is light-emitting;
particles or agglomerates of particles of pigments or dyes of the Hi-lite type, that are visible or invisible, and in particular that are light-emitting;
security fibers, in particular metallic, magnetic (having soft and/or hard magnetism), or absorbent, or excitable using ultraviolet, visible, or infrared light, and in particular light in the near infrared (NIR);
photochromic or thermochromic ingredients; and
a security element that is readable automatically having specific and measurable characteristics in terms of emitting light (e.g. fluorescence, phosphorescence), of absorbing light (e.g. UV, visible, or IR light), Raman activity, magnetism, microwave interaction, X-ray interaction, or electrical conductivity.

One or more security elements as defined above may be present in the sub-structure and/or the fiber layer(s) or in one or more security elements incorporated in the sub-structure and/or in the fiber layer(s), such as for example a thread, a fiber, or a flake.

The structure may also include one or more “falsification-proofing” security element such as, for example: reagents to chemicals, e.g. capable of producing a colored reaction in the presence of specific chemicals, e.g. chemicals used by fraudulent people.

### Fiber Layer(s)

The structure may include at least one fiber layer that may carry a watermark or a pseudo-watermark, and preferably the structure has two fiber layers, each carrying a watermark or a pseudo-watermark, as mentioned above.

The two watermarks or pseudo-watermarks of the two fiber layers may advantageously not combine in register with the translucent region of the sub-structure.

The watermark or pseudo-watermark of a fiber layer may include a portion outside the translucent region of the sub-structure that does combine with a portion of the watermark or pseudo-watermark of the other fiber layer, and another portion in the translucent region of the sub-structure that does not combine with any portion of the watermark or pseudo-watermark of the other fiber layer.

The watermark or pseudo-watermark of each fiber layer may be visible at least in part only from the face of the fiber layer that includes it, in particular in register with the translucent region of the sub-structure. The watermark or pseudo-watermark of each fiber layer may be visible at least in part from the face of the fiber layer that does not include it, in particular away from the translucent region of the sub-structure.

It is also possible for each of the two fiber layers to include one or more watermarks or pseudo-watermarks that combine together outside the translucent region of the sub-structure in order to form a pattern.

The fiber layer(s) may be made on a flat bed (fourdrinier) or vat roll paper-making machine, and the watermarks may be incorporated in the fiber layer(s) in the wet portion using conventional paper-making methods known to the person skilled in the art.

The fiber layer(s) may also be made on a flat bed (fourdrinier) or vat roll paper-making machine with pseudo-watermarks being made on the finished layers by mechanical or chemical means using conventional methods known to the person skilled in the art.

At least one fiber layer may include printing, e.g. offset, photogravure, silkscreen or flexograph, copper-plate, typography, laser, or ink jet printing. The printing may for example correspond to permanent and/or variable mentions of an identity document. The printing may include a photograph, e.g. a photograph of the holder of the document.

At least one fiber layer may be based for example on paper of the Laserguard® or Jetguard® type sold by the supplier Arjowiggins.

At least one fiber layer may be colored, fluorescent, iridescent, or may present any other optical effect or shade.

At least one fiber layer may be based on cellulose fibers, and/or synthetic fibers, and/or natural organic fibers other than cellulose fibers, and/or mineral fibers.

At least one fiber layer may present weight lying in the range 60 grams per square meter (g/m²) to 120 g/m², preferably lying in the range 70 g/m² to 90 g/m².

At least one fiber layer may have thickness lying in the range 60 micrometers (μm) to 120 μm, preferably in the range 70 μm to 110 μm, e.g. about 100 μm.

In an embodiment of the invention, at least one fiber layer includes a recess, e.g. an opening in the form of a space without fibers, e.g. made on a paper-making machine or away from a paper-making machine, e.g. by punching out, by laser-cutting, or by waterjet-cutting. The recess is preferably made in a portion of the fiber layer that does not include or does not cover the integrated microcircuit device. Each of the two fiber layers may include such a recess, with the recesses being in register with each other, for example. As a result, the structure may present a window that is transparent because of the transparency of the sub-structure. This window may constitute a security element or it may house one or more security elements, in particular optical elements, or it may make them easier to observe. For example, one or more security elements, in particular optical security elements, may be situated in the sub-structure, and may be observable through the above-mentioned window. This window may also be personalized, e.g. to show a pattern or an element that is printed, embossed, or perforated, relating to the carrier or to the article to which it refers.

First printing may be performed on the recto face of the sub-structure, second printing may be performed on the verso face of the sub-structure, and when observing through the above-mentioned window, a complementary pattern may appear by the moire effect between the printing on the recto and verso faces.

Each of the recess(es) present in at least one fiber layer may present an area lying in the range 0.1 square centimeters (cm²) to 10 cm². The recess(es) may present arbitrary geometrical shape, in particular a shape that is rectangular or circular.

At least one fiber layer may include perforations, e.g. each having an area lying in the range 0.2 square millimeters (mm²) to 7 mm², e.g. for a diameter lying in the range 0.5 millimeters (mm) to 3 mm. Such perforations may be advantageous in that, during assembly of the structure, they enable an adhesive, e.g. forming part of the sub-structure, e.g. a transparent thermoplastic material, to diffuse through one or more fiber layers and thus bond the entire structure together more effectively.

The perforations may form a pattern, such as an alphanumeric pattern, and/or a design, and/or a symbol, so as to provide additional security to the structure.

In a particular embodiment, at least one fiber layer includes a patch or a strip that is at least partially transparent and at least one zone having no fibers that is situated in register with the patch or the strip. The strip or the patch may comprise a transparent plastics material, and may, where appropriate, include one or more security elements such as holographic printing or liquid crystals. Two zones having no fibers may be situated respectively in each of the fiber layers, in register with each other, so as to form a through window making it possible to see through the strip or the patch.

At least one fiber layer may include at least one “anti-scraping” security zone that provides it with protection against mechanical falsification. This zone may comprise a set of regions of reduced thickness, such that any attempt at altering the surface of this fiber layer perforates it. Such a security zone is described in patent EP 1 252 389.

### Sub-Structure

The sub-structure may include a translucent region or it may be translucent over its entire area. The sub-structure may include a translucent and/or light-diffusing region or it may be translucent and/or light-diffusing over its entire area.

The term “translucent” is used to mean that the sub-structure allows enough light to pass to be able to see through the structure. The term “diffusing” is used to mean that the sub-structure diffuses the light as a result of its nature and its thickness. More particularly, depending on the refractive index of the sub-structure, it may present the ability to diffuse light.

The translucent region may extend from one edge to the other of the sub-structure.

The translucent region may form an arbitrary pattern and it may be of a shape that is, for example: rectangular, triangular, square, circular, oval, polygonal, star-shaped, among others.

The translucent region preferably has the same thickness as the sub-structure.

By way of example, the translucent region may occupy more than 50%, better more than 70% or 80%, better still more than 90% of the volume corresponding to the sub-structure.

The sub-structure may include a plurality of translucent regions, e.g. more than two, three, or four translucent regions. These translucent regions may be disposed on the sub-structure optionally in regular manner, e.g. with identical spaces between the regions, or they may be disposed randomly. The translucent regions may form a pattern, e.g. being placed close to one another.

When the sub-structure has two separate or juxtaposed translucent regions, the regions may be made differently, e.g. with different levels of opaqueness, so as to create show-through effects.

The sub-structure may also include organic or inorganic fillers, bubbles, or cavities that give it a diffusing character.

The thickness of the sub-structure may lie in the range 100 μm to 1000 μm, and preferably in the range 400 μm to 600 μm.

The sub-structure may present one or more recesses as described above for the fiber layer(s).

The sub-structure may be a single layer or it may be built as an assembly of two or more layers, e.g. two, three, or four layers, in particular fiber and/or polymer layers. The layers may be made of materials that are identical or different, e.g. such as those described below for the sub-structure.

The sub-structure may include one or more layers that are assembled together using one or more layers of adhesive, e.g. as defined below, or indeed without adhesive, by melting or heat-sealing.

The antenna associated with the integrated microcircuit device may be situated between two layers constituting the sub-structure, e.g. being adhesively-bonded to one face of one of the layers.

The thicknesses and the natures of the layers of the sub-structure are advantageously selected in such a manner that the sub-structure, in particular in the translucent region, presents desired properties of non-opaqueness and of diffusion, so as to prevent combining the watermarks or pseudo-watermarks of the fiber layers when the structure is observed in transmitted light.

The sub-structure may include a layer of thermoplastic material, in particular of polyethylene (PE), of polyvinyl chloride (PVC), of polyethylene terephthalate (PET), of polycarbonate (PC), of polyester carbonate (PEC), of polyethylene terephthalate glycol (PETG), or of acrylonitrile butadiene styrene (ABS), e.g. in the form of a film or of an extruded layer.

The sub-structure may also include or be constituted by a fiber layer, in particular a paper, e.g. a tracing paper.

The sub-structure may be composite and comprise at least one polymer layer and one fiber layer, each layer being selected, for example, from the above-mentioned materials.

The sub-structure may also include organic materials, e.g. selected from: corn (maize) starch, potato starch, vegetable fibers, in particular bamboo fibers, among others.

The sub-structure may extend over the entire area of the watermarks or the pseudo-watermarks.

The sub-structure may extend over a portion of the structure, preferably from one edge to the other of the structure, in a zone in register with the watermarks or pseudo-watermarks, e.g. so as to constitute a strip.

The sub-structure may extend over only a fraction of the area of the watermarks or pseudo-watermarks, so that some of the watermarks or pseudo-watermarks can thus be seen only from one face of the structure while the fraction that is not covered by the sub-structure is visible from both sides of the structure in transmitted light.

### Adhesive Layer(s)

The structure may include at least one adhesive layer, e.g. between a fiber layer and the sub-structure.

In particular, the structure may include two adhesive layers on either side of the sub-structure.

The adhesive layers may be of different natures.

At least one adhesive layer may comprise a polyolefin, e.g. polyethylene.

At least one adhesive layer may include an ethylene vinyl acetate.

In general, at least one adhesive layer may include a material as mentioned above for the sub-structure.

At least one adhesive layer may include a cross-linking agent. This embodiment may for example enable adhesion between the various layers to be reinforced. In particular, the cross-linking agent of the adhesive layer may be cross-linkable under the action of radiation, in particular ultraviolet radiation.

Assembling the Fiber Layer(s) with the Sub-Structure

The fiber layer(s) may be assembled to the sub-structure in various ways, e.g. via one or more adhesive layers or without an adhesive layer, e.g. by melting or by heat-sealing.

The sub-structure may present on at least one of its faces a polymer layer, e.g. a polycarbonate layer, capable of enabling it to be heat-sealed directly and under pressure to the fiber layer(s).

The sub-structure may also present on at least one of its faces a layer of polymer coated in an adhesive, e.g. a layer of polyethylene terephthalate coated in a layer of ethylene vinyl acetate, enabling it to be sealed directly to the fiber layers, cold or hot, and with or without pressure.

The fiber layer(s) may present surface coating on their faces facing the sub-structure suitable for enabling them to be bonded directly while hot and under pressure to the sub-structure. For example, the fiber layer(s) may comprise a paper substrate impregnated with a heat-sealing latex.

The fiber layer(s) may present an adhesive layer on their faces facing the sub-structure that enables them to be sealed directly to the sub-structure, cold or hot, and with or without pressure. The adhesive layer(s) present on the fiber layer(s) may correspond to liquid adhesives that are previously coated cold or hot on the face(s) of the fiber layer(s) facing the sub-structure.

In another embodiment, one or more adhesive layers, preferably layers that are optically diffusing and not opaque, are used to assemble the fiber layer(s) with the sub-structure. By way of example, the adhesive layer(s) may correspond to one or more thermoplastic or pressure-sensitive films.

The sub-structure may also include one or more openings or perforations, preferably that do not overlie the electronic device and/or any antenna, so as to enable the adhesive layer(s) used to assemble the fiber layers with the sub-structure to mix together and thus provide better fastening of the sub-structure with the fiber layer(s).

At least one adhesive layer may include one or more security elements as described above.

### Outer Layer(s)

The structure may include at least one outer layer covering at least one fiber layer on its side remote from the sub-structure.

The structure may include two outer layers covering respective ones of the two fiber layers on their outside faces. The two outer layers may be joined together at least in part at the edges of the structure.

At least one fiber layer may be of a width that is less than the width of the sub-structure, and possibly of one or both outer layers.

In particular, two fiber layers may have widths that are less than that of the sub-structure and possibly less than that of one or more outer layers.

In both of the above-mentioned configurations, the structure may include two outer layers that are joined to the sub-structure via the edges of the structure.

The outer layer(s) may make it possible, in particular, to protect the fiber layer(s), and in particular any permanent and/or variable mentions and printing performed on the fiber layer(s).

At least one outer layer may be in the form of a protective layer, e.g. of a transparent polymer, e.g. in the form of a film or a pouch for laminating, of thickness lying for example in the range 100 μm to 250 μm, e.g. so as to obtain a structure presenting greater resistance to wear and to being used.

At least one outer layer may include a film of polymer, as described for the sub-structure, e.g. of polyolefin, e.g. of polyethylene, polyethylene terephthalate, polyester, polycarbonate, polystyrene, cellulose ester, polyolefin, polysulfone, or polyimide.

At least one outer layer may be laminated on at least one fiber layer of the structure, e.g. by means of an adhesive, e.g. polyethylene, polyester, polyester urethane, polyether urethane, said adhesive being coated, extruded, or transferred, for example, onto one of the faces of at least one outer layer.

At least one outer layer may also be laminated directly by melting onto at least fiber layer of the structure, e.g. using the method described in Landquart's patent EP 1 556 228.

At least one outer layer may include one or more security elements, e.g. such as those described above. By way of example, the security element(s) may correspond to printing that is fluorescent, phosphorescent under ultraviolet light, optically variable elements, infrared waveguides, and optionally transferable.

### Spacer Layer

The structure may include at least one spacer layer placed between the outer layers covering the fiber layer(s) and of thickness that compensates for the total thickness of the fiber layer(s) and of the sub-structure layer(s).

The spacer layer may present a recess of shape that is substantially identical to that of the sub-structure, e.g. of width and of length equal to the width and the length of the sub-structure, and of thickness that is greater than or equal to the thickness of the assembly formed by the sub-structure plus the fiber layer(s).

In another embodiment of the invention, the spacer layer presents a recess of a shape that is substantially identical to that of the sub-structure, e.g. of width and of length that are equal to the width and the length of the sub-structure, and of thickness that is not less than that of the sub-structure.

In yet another embodiment of the invention, the spacer layer presents a recess of shape that is substantially identical to the shape of the sub-structure and of the fiber layer(s), e.g. of width and of length that are equal to the width and the length of the sub-structure and of the fiber layer(s), and of thickness that is not less than the thickness of the assembly formed by the sub-structure and the fiber layer.

The outer layer(s) may cover the spacer layer, at least in part, only on the faces of the spacer layer that are of the greatest size, in particular the top and bottom faces.

The spacer layer may for example be of a fibrous nature or preferably of a polymer nature, which may for example improve the ability of the structure to withstand wear and use along its edges and may also serve to protect the fiber layers and the sub-structure from moisture.

The spacer layer may be transparent, translucent, or opaque.

The spacer layer may be constituted by one or more materials as described for the sub-structure.

The spacer layer may have thickness lying in the range 100 μm to 1000 μm, and preferably in the range 400 μm to 600 μm.

The spacer layer may include one or more security elements such as those described above. In particular, the spacer layer may include light-emitting pigments and/or dyes and/or interference pigments and/or liquid crystal pigments, e.g. deposited or mixed in the spacer layer.

The spacer layer may also perform a security function, e.g. by acting as a filter, e.g. by polarizing or guiding light. In particular, the spacer layer may be a collector of light that is of light-emitting origin.

At least one spacer layer may include a light emitter, in particular a light-emitting diode.

The light may pass through or diffuse through the spacer layer and it may optionally be collected or detected by any suitable device.

### Structure

The structure of the invention may present a final thickness lying in the range 0.2 mm to 3 mm, and preferably in the range 760 μm to 840 μm. The structure may be an identity document, in particular an identity card or a passport, payment means, in particular a payment card, a requisition order or voucher, a ticket giving access to cultural or sporting events, a loyalty card, or an authenticity certificate.

The structure may be constant in thickness. In a variant, the structure may present varying thickness, in particular the structure may be thicker in a central portion than at its edges.

In another of its aspects, the invention also provides a sheet having a recto face and a verso face and at least one watermark, and such that said watermark is observable in transmitted light, at least in part, from only one of the faces of said sheet.

The invention can be better understood on reading the following detailed description of non-limiting examples of implementations thereof, and on examining the diagrammatic and fragmentary figures of the accompanying drawings, in which:

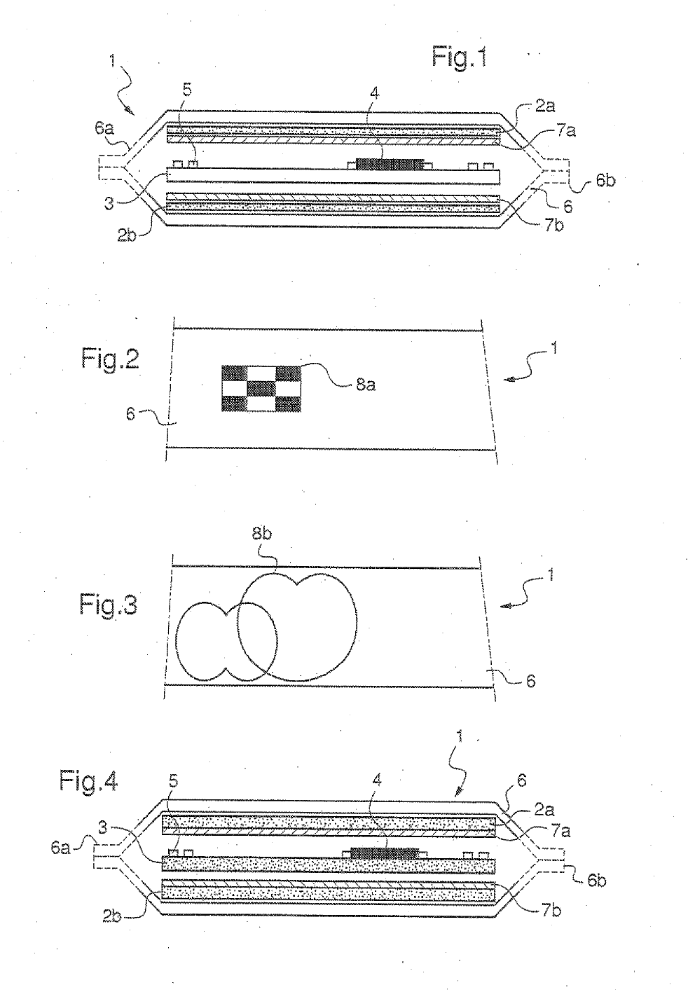

FIG. 1 is a section view of an example structure of the invention;

FIG. 2 is a face view of the recto face of the FIG. 1 structure;

FIG. 3 is a face view of the versa face of the FIG. 1 structure;

FIGS. 4 to 11 show other examples of structures of the invention;

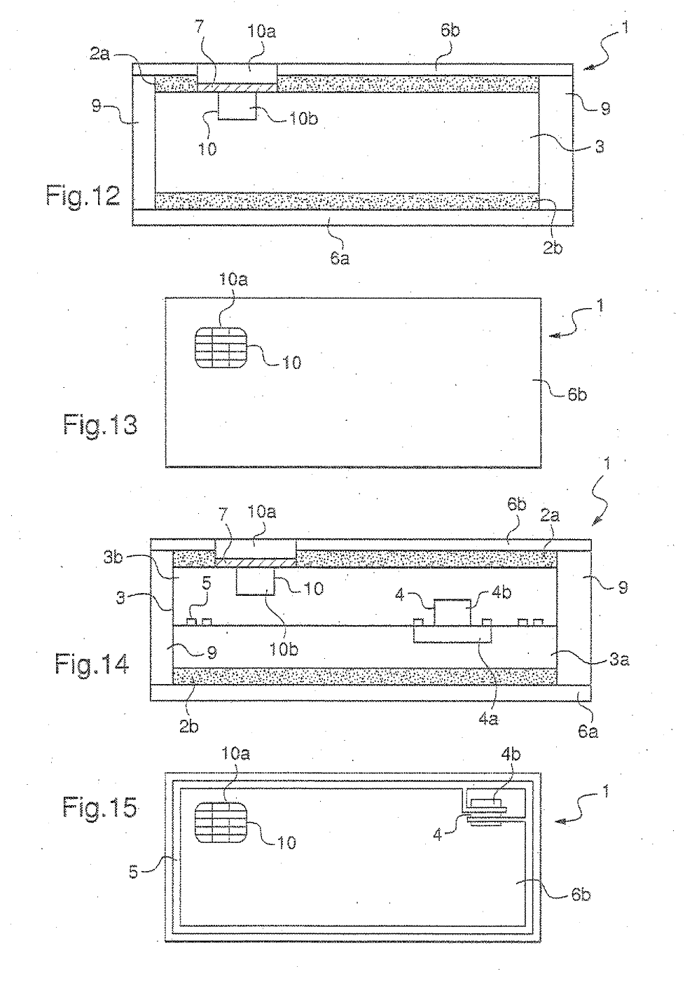

FIGS. 12, 14, and 16 show other examples of structures of the invention, each including an incorporated microcircuit device for communication via contacts;

FIGS. 13, 15, and 17 are face views of the recto faces of the structures of FIGS. 12, 14, and 16 respectively;

FIG. 18 is a section view of another example of a structure of the invention;

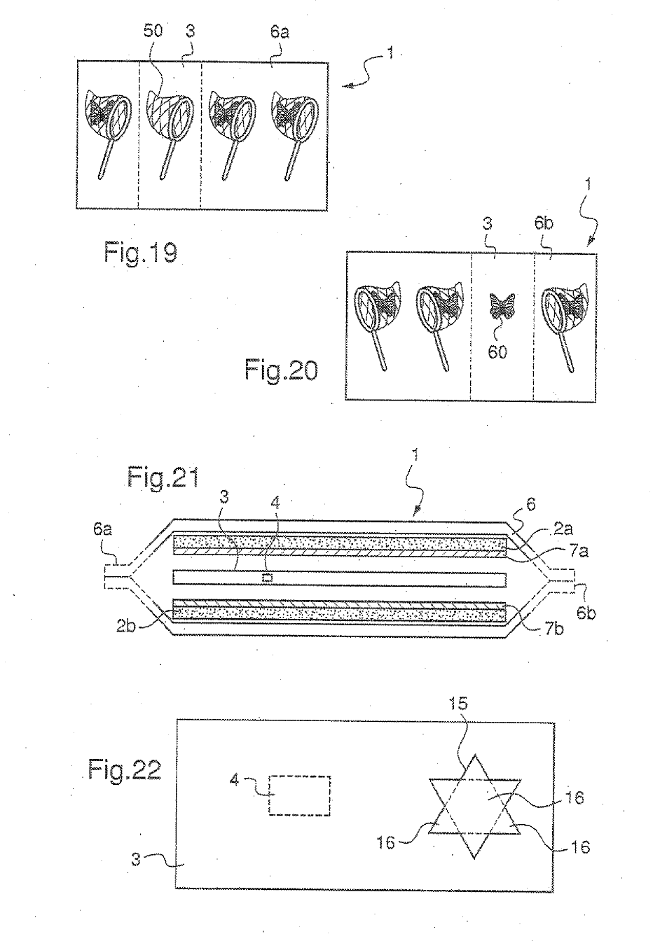

FIGS. 19 and 20 are face views respectively of the recto and verso faces of the FIG. 18 structure;

FIG. 21 is a section view of another example of a structure of the invention; and

FIG. 22 is a face view of the sub-structure of the FIG. 21 structure.

In the drawings, proportions between the various elements shown are not always true to scale for reasons of clarity.

FIG. 1 shows an example of a structure 1 in accordance with the invention.

The structure 1 comprises two fiber layers 2a and 2b having a sub-structure 3 situated between them, the sub-structure 3 comprising a polymer interlayer having a contactless integrated microcircuit device 4 and an antenna 5 placed thereon. In this example, the sub-structure 3 is entirely translucent.

The structure 1 also includes an adhesive layer 7a placed between the sub-structure 3 and the fiber layer 2a, and another adhesive layer 7b placed between the sub-structure 3 and the fiber layer 2b.

The assembly as formed in this way by the fiber layers 2a and 2b, the adhesive layers 7a and 7b, and the sub-structure 3 is placed between two outer layers 6a and 6b that are in the form of an outer envelope 6 that is pre-sealed along one edge, also referred to as a pouch. In this example, the outer envelope 6 is transparent.

Because of the thickness of the assembly constituted by the various superposed layers, the structure 1 presents greater thickness in its central portion than it does at the edges of the structure 1.

In the example described, the outer envelope 6 is made of films of polyethylene terephthalate coated in polyethylene thermoplastic on their inside faces.

The adhesive layers 7a and 7b in this example are in the form of polyethylene thermoplastic films suitable for lamination by cold rolling. The polyethylene layer 7a provides partial or complete compensation for the integrated microcircuit device 4, with the polyethylene thermoplastic layer creeping on either side of the integrated microcircuit device 4 during rolling.

In this example, the sub-structure 3 comprises a single layer in the form of a transparent polyethylene terephthalate film having a thickness of at least 100 μm.

On one of its faces, the sub-structure 3 carries the integrated microcircuit device 4, which may be in the form of a chip as sold by the supplier Philips under the reference Mifare®.

The integrated microcircuit device 4, is connected to an antenna 5, e.g. a copper antenna etched on one of the faces of the sub-structure 3.

By way of example, both fiber layers 2a and 2b present weight that is equal to 90 g/m².

The fiber layer 2a includes a watermark or a pseudo-watermark 8a, e.g. in the form of a checkerboard as shown, and the fiber layer 2b includes a watermark or a pseudo-watermark 8b, e.g. in the form of a cardioid or a nephroid in association.

Each of the watermarks or pseudo-watermarks 8a and 8b can be seen from only one side of the structure 1. In particular, the watermark or pseudo-watermark 8a is visible only from the recto side of the structure 1 where the fiber layer 2a appears, and the watermark or pseudo-watermark 8b is visible only from the verso side of the structure 1 where the fiber layer 2b appears.

FIG. 2 is a face view of the recto face of the FIG. 1 structure 1.

In this figure, it can be seen that when the structure 1 is illuminated from its verso side, only the watermark or pseudo-watermark 8a on the recto side of the structure 1 is observed.

FIG. 3 is a face view of the verso face of the FIG. 1 structure 1.

In this figure, it can be seen that when the recto face of the structure 1 is illuminated, only the watermark or pseudo-watermark 8b of the verso side of the structure 1 can be seen.

FIG. 4 shows another example of a structure 1 of the invention.

In this example, the structure 1 comprises an outer envelope 6 and two fiber layers 2a and 2b, e.g. identical to those of the example of FIG. 1. The outer envelope 6 is thus likewise transparent in this example.

The structure 1 also includes a sub-structure 3 comprising a translucent fiber interlayer having a device comprising a contactless integrated microcircuit device 4 and an antenna 5 on one of its faces. The sub-structure 3 is advantageously entirely translucent.

By way of example, the sub-structure 3 is made of tracing paper and its weight is equal to 65 g/m², for example.

The integrated circuit device 4 may, for example, be a chip of the “flip chip” type that is connected to an antenna 5, e.g. based on silver and silkscreen-printed.

Each of the fiber layers 2a and 2b also includes a respective adhesive layer 7a or 7b, e.g. in the form of a pressure-sensitive adhesive, previously coated at 25 g/m², for example, on the inside faces of the fiber layers 2a and 2b.

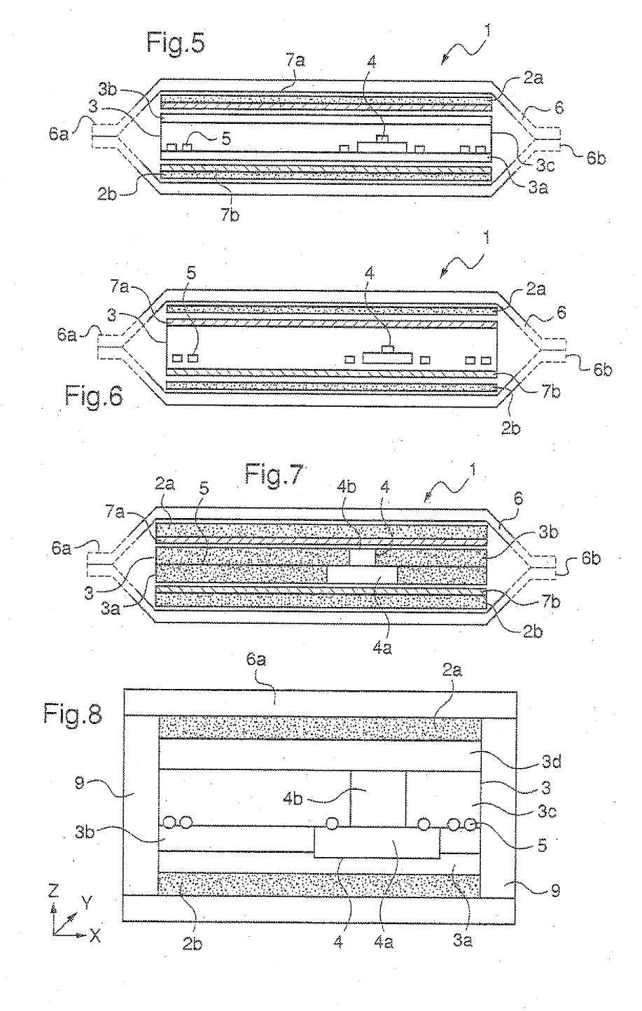

FIG. 5 shows another example of a structure 1 of the invention.

The structure 1 comprises an outer envelope 6 and two fiber layers 2a and 2b, e.g. identical to those of the example of FIG. 1. The outer envelope 6 is thus likewise transparent in this example. Both of the fiber layers 2a and 2b are coated on their inside faces by respective adhesive layers 7a and 7b enabling them to be subsequently bonded to the sub-structure 3.

The structure 1 also includes a sub-structure 3 comprising three interlayers 3a, 3b, and 3c. In this example, the sub-structure 3 is entirely translucent.

By way of example, the layer 3a is a film of transparent polyethylene terephthalate having the integrated microcircuit device 4 and the antenna 5 placed on one of its faces.

By way of example, the integrated microcircuit device 4 is a chip sold by the supplier Philips under the reference Mifare®, and it is connected to the antenna 5 which is an etched copper antenna, for example.

By way of example, the layer 3b is a film of transparent polyethylene terephthalate having the layer 3c coated thereon, which layer may for example be a layer of transparent polyethylene and ethylene vinyl acetate thermoplastic. The layer 3c presents thickness that is greater than or equal to the thickness of the integrated microcircuit device 4 so as to compensate for the thickness of said device.

FIG. 6 shows another example of a structure 1 of the invention.

The structure 1 comprises an outer envelope 6 of polyethylene terephthalate coated in polyethylene so as to form a transparent pouch.

The outer envelope 6 may for example present thickness in the central portion of the structure 1 that is equal to 175 μm, comprising a thickness of polyester equal to 125 μm and a thickness of polyethylene equal to 50 μm.

The structure 1 also includes two fiber layers 2a and 2b, e.g. weighing 90 g/m² and of thickness equal to 95 μm.

The structure 1 also includes a sub-structure 3 that may be constituted by a plurality of transparent layers of polyethylene terephthalate and of ethylene vinyl acetate (not shown), some of which present at least one recess suitable for incorporating an integrated microcircuit device 4 in the form of a chip module connected to an antenna 5. The sub-structure 3 is advantageously entirely translucent.

Two adhesive layers 7a and 7b are also present on either side of the sub-structure 3 so as to provide cohesion with the fiber layers 2a and 2b. The adhesive layers 7a and 7b are constituted, for example, by heat-sealing layers of ethylene vinyl acetate enabling the sub-structure 3 to be laminated directly between the two fiber layers 2a and 2b.

The total thickness of the sub-structure 3 plus the two adhesive layers 7a and 7b is 560 μm.

FIG. 7 shows another example of a structure 1 of the invention.

The structure 1 comprises an outer envelope 6 and two fiber layers 2a and 2b, e.g. respectively identical to the outer envelope 6 and to the fiber layers 2a and 2b of the example of FIG. 6.

The fiber layers 2a and 2b of the structure 1 are pre-coated on their inside faces with respective adhesive layers 7a and 7b that are heat-activated and thermosetting, which layers are applied in the form of liquid adhesives that are based on polyurethane mixed with a blocked isocyanate.

The structure 1 also includes a sub-structure 3, e.g. having thickness of 260 μm. In this example, the sub-structure is entirely translucent.

The sub-structure 3 includes a paper layer 3a, e.g. having thickness equal to 130 μm, and having a wire antenna 5 of copper on one of its faces, e.g. secured by ultrasound, and including a recess in which a contactless integrated microcircuit device 4 is received in part.

The sub-structure 3 also includes a paper layer 3b, e.g. having thickness equal to 130 μm, likewise including a recess in register with the recess in the layer 3a and receiving at least part of the integrated microcircuit device 4.

By way of example, the integrated microcircuit device 4 is a chip module of the MOB 6 type sold by the supplier Philips.

In all of the examples of FIGS. 4 to 7, the fiber layers 2a and 2b of the structure 1 include one or more watermarks or pseudo-watermarks, e.g. as described for the example of FIG. 1.

FIG. 8 shows another example of a structure 1 of the invention.

The structure 1 comprises a sub-structure 3 made up of four layers 3a, 3b, 3c, and 3d, and it completely incorporates a contactless integrated microcircuit device 4.

In this example, the layer 3a is constituted by a layer of polycarbonate without any recess, presenting thickness of 100 μm.

In this example, the layer 3b is constituted by a layer of polycarbonate having a thickness of 100 μm and presenting a recess in which a portion 4a of the integrated microcircuit device 4 is received, the portion 4a corresponding in particular to the base of a MOB 4 type module sold by the supplier NXP, a subsidiary of the supplier Philips. The layer 3b also includes a wire antenna 5 on one of its faces that is connected to the integrated microcircuit device 4.

In this example the layer 3c is constituted by a layer of polycarbonate having a thickness of 200 μm and presenting a recess in which a portion 4b of the integrated microcircuit device 4 is received, said portion 4b corresponding in particular to the potting projection of a MOB 4 type module.

The fiber 3d of the sub-structure 3 in this example is constituted by a layer of polycarbonate without any recess and having thickness of 100 μm.

The sub-structure 3 is thus advantageously entirely translucent.

The structure 1 also includes two fiber layers 2a and 2b, e.g. weighing 80 g/m², and capable of presenting one or more watermarks or pseudo-watermarks, e.g. the above-described watermark(s) or pseudo-watermark(s) 8a or 8b.

The structure 1 has two outer layers 6a and 6b, e.g. constituted by a protective film of transparent polycarbonate having thickness equal to 100 μm.

The structure 1 also includes a spacer layer 9 for compensating the thicknesses of the fiber layers 2a and 2b and of the sub-structure 3, and enabling the structure 1 to present thickness that is substantially constant so as to satisfy the specifications for an ISO type card having a thickness of 800 μm.

By way of example, the spacer layer 9 is constituted by a layer of transparent polycarbonate presenting a recess of width and of length that are equal to the width and the length of the assembly formed by the sub-structure 3 and the fiber layers 2a and 2b, i.e. 80 mm by 50 mm, for example, and presenting thickness equal to the thickness of the assembly formed by the sub-structure 3 and the fiber layers 2a and 2b, e.g. equal to 600 μm.

In this example and in the following examples, other than that of FIG. 10, the spacer layer 9 may present dimensions along the X and Y axes that are greater than along the Z axis. In particular, the height of the spacer layer 9 along the Z axis may be smaller than its length and/or its width along the X and Y axes. The outer layers 6a and 6b need cover the spacer layer 9 only on faces parallel to the X axis, i.e. its top and bottom faces.

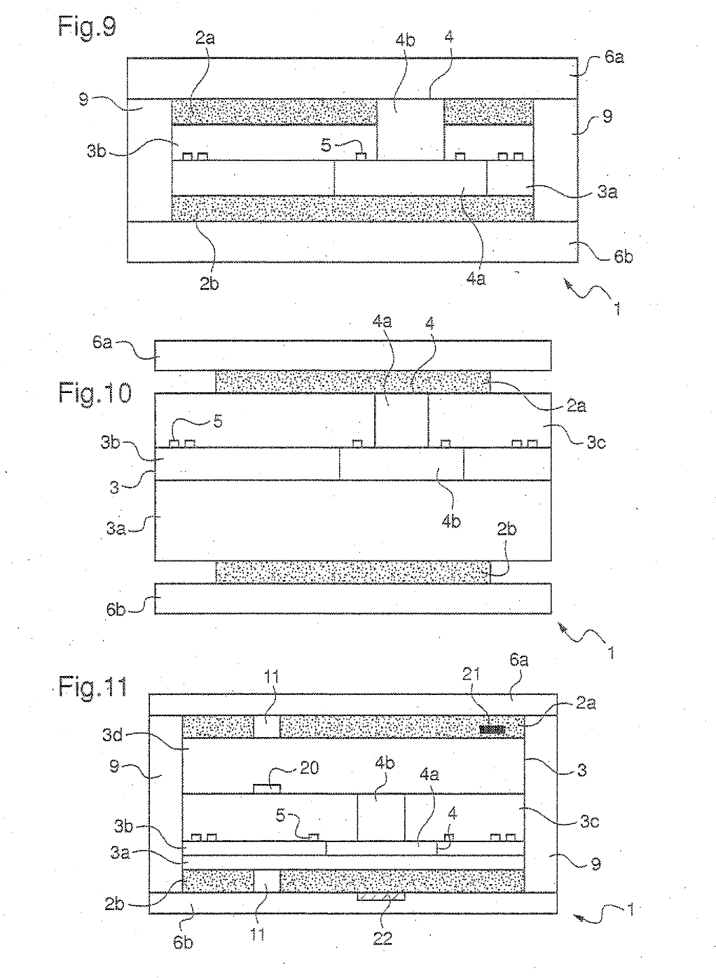

FIG. 9 shows another example of a structure 1 of the invention.

The structure 1 includes a sub-structure 3 that is entirely translucent, presenting two layers 3a and 3b and incorporating part of a contactless integrated microcircuit device 4.

In this example, the layer 3a of the sub-structure 3 is constituted by a polycarbonate layer having thickness of 130 μm, presenting a recess in which a portion 4a of the integrated microcircuit device 4 is received, the portion 4a serving to receive the base of a MOB type module 4 sold by the supplier NXP, a subsidiary of the supplier Philips. The portion 4a also supports a wire antenna 5 on one of its faces, which antenna is connected to the integrated microcircuit device 4.

In this example, the layer 3b is constituted by a polycarbonate layer having thickness of 130 μm and presenting a recess in register with the recess in the layer 3a and receiving a portion 4b of the integrated microcircuit device 4, the portion 4b corresponding to the potting projection of a MOB 4 type module.

The structure 1 also includes two fiber layers 2a and 2b, e.g. weighing 70 g/m² and having a thickness of 70 μm.

The fiber layer 2a also includes a recess in register with the recesses in the layers 3a and 3b, and receiving a portion 4b of the integrated microcircuit device 4, the portion 4b corresponding to the potting projection of a MOB 4 type module.

The structure 1 also includes two outer layers 6a and 6b, e.g. constituted by protective films of transparent polycarbonate and presenting thickness equal to 200 μm, for example.

Finally, a spacer layer 9 is incorporated in the structure 1 in order to compensate for the thicknesses of the fiber layers 2a and 2b and of the sub-structure 3.

By way of example, the spacer layer 9 is made of transparent polycarbonate and presents a recess of width and of length equal to the width and the length of the assembly formed by the sub-structure 3 plus the fiber layers 2a and 2b, e.g. equal to 80 mm by 50 mm, and presents a thickness that is equal, for example, to the thickness of the assembly formed by the sub-structure 3 and the fiber layers 2a and 2b, e.g. equal to 400 μm.

FIG. 10 shows another example of a structure 1 of the invention.

The structure 1 includes a completely translucent sub-structure 3 presenting three layers 3a, 3b, and 3c having fully incorporated therein a contactless integrated microcircuit device 4.

By way of example, the layer 3a is constituted by a layer of polycarbonate that does not include a recess and that presents a thickness of 200 μm.

By way of example, the layer 3b is a layer of polycarbonate, of thickness equal to 100 μm, and presenting a recess in which a portion 4b of the integrated microcircuit device 4 is received, e.g. corresponding to the base of a MOB 4 type module. The layer 3b also supports a wire antenna 5 on one its faces, the antenna being connected to the integrated microcircuit device 4. By way of example, the layer 3c is constituted by a layer of polycarbonate, of thickness equal to 200 μm, and presenting a recess in which a portion 4a of the integrated microcircuit device 4 is received, e.g. corresponding to the potting projection of a MOB 4 type module.

The structure also includes two fiber layers 2a and 2b, e.g. weighing 65 g/m², the two fiber layers 2a and 2b having, for example, dimensions that are smaller than those of the sub-structure 3 and of the outer layers 6a and 6b, e.g. of width that is less than the width of the outer layers 6a and 6b and of the sub-structure 3.

As a result, during lamination, the outer layers 6a and 6b of transparent polycarbonate and of thickness equal to 100 μm in this example are capable of fusing with the sub-structure 3, e.g. likewise made of polycarbonate, at the edges of the structure 1 that do not have any fiber layer. Advantageously, this embodiment is preferable when the fiber layers 2a and 2b are fine and compressible so as to provide the best possible contact between the various polycarbonate layers.

FIG. 11 presents a variant of the embodiment of the structure 1 shown in FIG. 8. In this example, additional security features are incorporated in the structure 1.

By way of example, the layer 3d of the sub-structure 3 includes a print 20 on its inside face, which print fluoresces yellow under ultraviolet (UV) light at 365 nm.

By way of example, each of the fiber layers 2a and 2b includes a recess 11 in register with the other recess and in register with the fluorescent print 20 of the sub-layer 3d of the sub-structure 3. By way of example, the recesses 11 serve to form a transparent window that is observable in reflection and in transmission from both sides of the structure 1. The recesses 11 forming the transparent window may, for example, be in the shape of an emblem. The fiber layer 2a may for example include one or more security elements, e.g. visible blue fibers, invisible flakes that fluoresce green under ultraviolet (UV) light at 365 nm. The fiber layer 2b may also include one or more security elements, e.g. invisible fibers that fluoresce red, invisible flakes that fluoresce blue, invisible Hi-lites that fluoresce orange, all under ultraviolet (UV) light at 365 nm.

The fiber layer 2a may also include a security thread 21 in the form of a flat strip having a width of 2 mm, e.g. inserted in a window, in particular away from the region of the recess 11.

The fiber layer 2b may also include a holographic foil 22 applied by heat-transfer, protected by the outer fiber 6b, and situated in particular away from the recess 11. By way of example, the foil 22 may have a thickness of 6 μm and not require any thickness compensation.

The spacer 9 is made of a transparent polycarbonate that fluoresces red under ultraviolet (UV) light at 365 nm.

By observing under daylight in reflection, it is thus possible beside the outer layer 6a to see blue fibers and the security thread 21, and beside the outer layer 6b to see the holographic foil 22 and the blue flakes.

By observing under ultraviolet light in reflection, it is possible for example to see the transparent edges of the structure 1 corresponding to the width of the spacer layer 9 that fluoresce in red, and to see the yellow fluorescent print in the window formed by the recesses 11. It is also possible to see the light-emitting security features in the fiber layers 2a and 2b, and the security features (Hi-lite flakes, fibers) emitting light differently depending on which face of the structure 1 is observed.

FIG. 12 is a section view of another example of a structure 1 of the invention.

The structure 1 includes a single-fiber sub-structure 3 that is completely translucent, e.g. being constituted by a layer of polycarbonate and presenting a recess that receives a portion 10b of an integrated microcircuit device 10 having contacts.

The structure 1 also has two fiber layers 2a and 2b, each capable of including one or more watermarks or pseudo-watermarks, e.g. the watermarks or pseudo-watermarks 8a and 8b as described above.

The fiber layer 2a includes a recess receiving at least part of a portion 10a of the integrated microcircuit device 10.

The portions 10a and 10b of the integrated microcircuit device 10 may be connected together by an adhesive layer 7.

The structure 1 also includes two outer layers 6a and 6b, in this example made of transparent polycarbonate, the outer layer 6b presenting a recess in which the portion 10a of the integrated microcircuit device 10 is received, at least in part.

The structure 1 also includes a spacer layer 9, e.g. of transparent polycarbonate, the spacer layer presenting a recess of shape that is substantially identical to the shape of the assembly formed by the interlayer 3 and the fiber layers 2a and 2b, and of thickness that is equal, for example, to the thickness of the assembly constituted by the sub-structure 3 and the fiber layers 2a and 2b.

The structure 1 in this example thus presents three recesses formed in the outer layer 6b, the fiber layer 2a, and the sub-structure 3, serving to receive the integrated microcircuit device 10, which device may thus be visible and hence accessible in the surface of the structure 1 in the outer layer 6b, for example.

FIG. 13 is a plan view of the structure 1 of FIG. 12.

This figure shows that the integrated microcircuit device 10 and in particular the portion 10a of the integrated microcircuit device 10, is visible and thus accessible via the surface of the structure 1.

The integrated microcircuit device 10 has contacts and is thus equivalent to the chip of a smart card, being capable of communicating with an external reader.

FIG. 14 shows another example of a structure 1 of the invention.

In this example, the structure 1 includes both a contactless integrated microcircuit device 4 and an integrated microcircuit device 10 with contacts.

The sub-structure 3 is constituted by an assembly of a plurality of layers, in particular made of polycarbonate. By way of example, the sub-structure 3 may comprise a layer 3a including a recess in which the portion 4a of the contactless integrated microcircuit device 4 is received, e.g. a module as defined above. The layer 3a may also support a wire antenna 5 on one of its faces, which antenna is connected to the integrated microcircuit device 4. The sub-structure 3 is advantageously entirely translucent.

The sub-structure 3 may also include a layer 3b having a recess in which the portion 4b of the contactless integrated microcircuit device 4 is received, e.g. a device as defined above.

The structure 1 may also include two fiber layers 2a and 2b, outer layers 6a and 6b, and a spacer layer 9 as defined with reference to FIG. 12. The outer layer 6b, the fiber layer 2b, and the layer 3b of the sub-structure 3 may include recesses serving to receive the integrated microcircuit device 10 having contacts.

FIG. 17 is a plan view of the structure 1 of FIG. 14.

In this figure, there can be seen the antenna 5 connected to the contactless integrated microcircuit device 4, in particular because the outer layer 6b of the fiber layer 2a and of the sub-structure 3 are transparent.

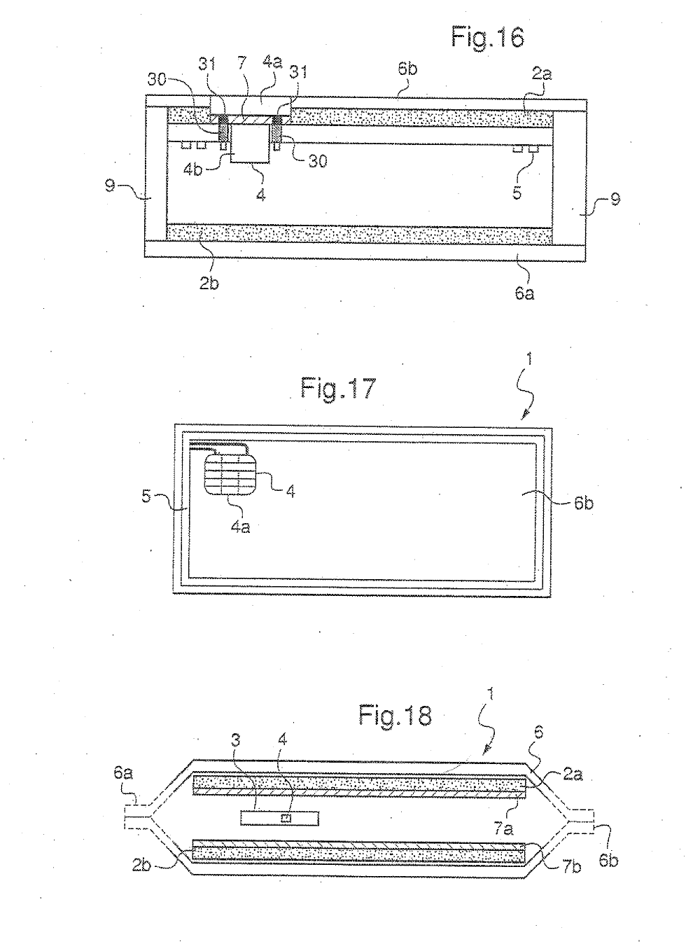

FIG. 16 shows another example of a structure 1 of the invention.

In this example, the structure 1 includes an integrated microcircuit device 4 of the “dual interface” type, i.e. an integrated microcircuit device including both a contactless interface and an interface with contacts.

The sub-structure 3 has two layers 3a and 3b, e.g. identical to those of FIG. 15, one of the layers including a wire antenna 5 connected to the integrated microcircuit device 4 by a conductive material 30. The sub-structure is thus advantageously entirely translucent.

The integrated microcircuit device 4 is housed in the outer layer 6b, the fiber layer 2a and the sub-structure 3, in the same manner as described for the integrated microcircuit device 10 in the examples of FIGS. 12 and 14.

The layer 3b also presents a recess enabling terminals 31 to be received for contacting the antenna 5.

FIG. 17 is a plan view of the FIG. 14 example of the structure 1.

In this figure, there can be seen the integrated microcircuit device 4 of the structure 1 together with the antenna 5, in particular because of the transparency of the various layers making up the structure 1.

In all of the examples of FIGS. 12 to 17, the thickness of the structure 1 is preferably constant, e.g. lying in the range 690 μm to 840 μm, and in particular in the range 760 μm to 840 μm.

FIG. 18 shows another example of a structure 1 of the invention.

In this example, the structure 1 has two fiber layers 2a and 2b that are coated on their inside faces with respective adhesive layers 7a and 7b.

The fiber layer 2a has a plurality of identical watermarks 50, as can be seen in FIG. 19 that shows the recto face of the structure 1 of FIG. 18.

The fiber layer 2b also has a plurality of identical watermarks 60, as can be seen in FIG. 20 that shows the verso face of the structure 1 of FIG. 18.

A sub-structure 3 in the form of an entirely translucent strip that diffuses light and that comprises one or more layers, is placed between the fiber layers 2a and 2b coated with the adhesive layers 7a and 7b. The sub-structure 3 advantageously presents dimensions, and in particular width, less than the dimensions of the fiber layers 2a and 2b. The sub-structure 3 extends from one edge to the other of the structure 1 in the width direction, as can be seen in FIGS. 19 and 20.

An integrated microcircuit device 4 in the form of an antenna on-board (AOB) type chip is incorporated in the sub-structure 3.

The assembly formed by the fiber layers 2a and 2b, the adhesive layers 7a and 7b, and the sub-structure 3 is placed between two outer layers 6a and 6b in the form of a transparent outer envelope 6 that is pre-sealed along one edge, also referred to as a pouch.

Advantageously, at least a portion of a watermark 50 of the fiber layer 20, and better all of it, and at least a portion of a watermark 60 of the fiber layer 2b, and better all of it, overlie the sub-structure 3.

When the recto face of the structure 1 is observed in register with the sub-structure 3, as shown in FIG. 19, only the watermark 50 of the fiber layer 2a is visible, and not the watermark 60 of the fiber layer 2b.

When the verso face of the structure 1 is observed in register with the sub-structure 3, as shown in FIG. 20, only the watermark 60 of the fiber layer 2b is visible and not the watermark 50 of the fiber layer 2a.

Advantageously, the watermarks 50 and 60 of the fiber layers 2a and 2b that do not overlie the sub-structure 3 are visible both from the recto side and from the verso side of the structure 1, as can be seen in FIGS. 19 and 20. Furthermore, these watermarks 50 and 60 may combine in such a manner as to produce a pattern that results from their combination, in this example representing a butterfly within a net.

Thus, in this example, the watermarks of the fiber layers 2a and 2b can be combined only away from the sub-structure 3.

FIG. 21 shows another example of a structure 1 of the invention.

The structure 1 comprises two fiber layers 2a and 2b, two adhesive layers 7a and 7b, and an outer envelope 6 identical to those of the structure 1 of FIG. 18.

In contrast, in this example, the structure 1 includes a sub-structure 3 that extends from one edge to the other of the structure 1 both in the length direction and in the width direction.

The sub-structure 3 includes a translucent region 15, e.g. obtained by juxtaposing a plurality of translucent regions 16 that together form a pattern, e.g. in the for of a star.

The fiber layers 2a and 2b may include one or more watermarks or pseudo-watermarks, e.g. of the kind described above, that preferably overlie at least in part in the translucent region of the sub-structure 3.

As described for the structure of FIG. 18, also shown in FIGS. 19 and 20, each portion of the watermark or pseudo-watermark that is in register with the translucent region 15 is visible only from the side of the structure 1 that includes the fiber layer that carries it. Away from the translucent region 15, the watermarks or pseudo-watermarks of the fiber layer 2a are capable, for example, of combining with the watermarks or pseudo-watermarks of the fiber layer 2b.

FIG. 22 shows a face view of the sub-structure 3 of FIG. 21, in which there can be seen the pattern that is formed by the translucent region 15.

In all of the examples described above, the integrated microcircuit devices 4 or 10 may include or be associated with one or more electronic devices in the form of detectors configured to detect a change in at least one physicochemical magnitude, in particular a physicochemical magnitude characteristic of a layer including the integrated microcircuit device in question, e.g. the sub-structure 3. As a result, it can be possible to communicate any attempt at violating the physical integrity of the structure as a result of detecting a change in the physicochemical magnitude.

The term “comprising a” is synonymous with “comprising at least one”, unless specified to the contrary.

1. A structure comprising:
a fiber layer;
a sub-structure including a translucent region;
a watermark or pseudo-watermark carried by the fiber layer and superposed at least in part with the translucent region of the sub-structure, such that, in the translucent region of the sub-structure, the watermark or pseudo-watermark is observable in light transmitted through the structure only from the face of the structure that is adjacent to the fiber layer; and
an integrated microcircuit device for communicating with or without contact.

2. (canceled)

3. (canceled)

4. A structure according to claim 1, including two fiber layers, the sub-structure being situated between the fiber layers.

5. A structure according to claim 4, each of the two fiber layers including a watermark or pseudo-watermark observable in light transmitted through the structure only from the face of the structure that is adjacent to the fiber layer carrying it.

6. A structure according to claim 1, the sub-structure being translucent.

7. A structure according to claim 1, the sub-structure diffusing light.

8. A structure according to claim 1, the sub-structure having thickness lying in the range 100 μm to 1000 μm.

9. (canceled)

10. (canceled)

11. (canceled)

12. A structure according to claim 1, the sub-structure including organic or inorganic fillers, bubbles, cavities imparting a diffusing character thereto.

13. A structure according to claim 1, the sub-structure including at least one layer of polyethylene (PE), of polyvinyl chloride (PVC), of polyethylene terephthalate (PET), of polycarbonate (PC), of polyester carbonate (PEC), of polyethylene terephthalate glycol (PETG), or of acrylonitrile butadiene styrene (ABS), in particular in the form of a film or of an extruded layer.

14. A structure according to claim 1, the sub-structure including at least one fiber layer.

15. (canceled)

16. (canceled)

17. A structure according to claim 1, the fiber layer(s) being printable by offset, photogravure, silkscreen or flexograph, copper plate, typography, laser, or ink jet printing.

18. A structure according to claim 1, at least one fiber layer presenting weight lying in the range 60 g/m2 to 120 g/m2.

19. A structure according to claim 1, at least one fiber layer including a recess.

20. A structure according to claim 19, including two fiber layers each including a recess, the two recesses being in register with each other so as to form a window.

21. A structure according to claim 1, including an integrated microcircuit device for communication with contact and an integrated microcircuit device for communication without contact.

22. A structure according to claim 1, including an integrated microcircuit device for communication with or without contact, associated with, one or more electronic devices selected from the following list:
a light-emitting system;
a display device;
a sensor;
a coupling antenna; and
a switch.

23. (canceled)

24. (canceled)

25. A structure according to claim 1, the integrated microcircuit device being placed on one of the faces of the sub-structure.

26. A structure according to claim 1, the integrated microcircuit device being incorporated at least in part in one of the fiber layers.

27. A structure according to claim 1, the integrated microcircuit device being completely incorporated in the sub-structure.

28. A structure according to claim 1, including an antenna associated with the integrated microcircuit device.

29. A structure according to claim 28, the antenna being situated between two layers making up the sub-structure.

30. A structure according to claim 1, including at least one adhesive layer between a fiber layer and the sub-structure.

31. A structure according to claim 1, including two adhesive layers on either side of the sub-structure.

32. A structure according to claim 1, including at least one transparent outer layer covering at least one fiber layer on its side remote from the sub-structure.

33. A structure according to claim 1, including two fiber layers and two transparent outer layers covering respective ones of the two fiber layers on their sides remote from the sub-structure.

34. A structure according to the claim 33, the two outer layers being united, at least in part, at the edges of the structure.

35. A structure according to claim 33, including a spacer layer placed between the outer layers, the spacer layer having thickness that compensates the total thickness of the fiber layers and of the sub-structure.

36. A structure according to claim 35, the spacer layer being transparent, translucent, or opaque.

37. (canceled)

38. (canceled)

39. A structure according to claim 1, including two fiber layers each including one or more watermarks or pseudo-watermarks that combine together outside the translucent region of the sub-structure so as to form a pattern.

40. A structure according to claim 1, the sub-structure and/or the fiber layer(s) and/or the outer layer(s) and/or the adhesive layer(s) and/or the spacer layer, including one or more visible or hidden security elements.

41. A structure according to claim 1, the sub-structure including an ultraviolet (UV) absorber.

42. A structure according to claim 1, having thickness that is constant.

43. A structure according to claim 1, of thickness that is greater in its central portion than at the edges of the structure.

44. (canceled)
